(19) United States
(12) Patent Application Publication
(10) Pub. No.: US 2004/0220065 A1
(43) Pub. Date: Nov. 4, 2004

(54) Ammonia-free alkaline microelectronic cleaning compositions with improved substrate compatibility

(76) Inventor: Chien-Pin Sherman Hsu, Basking Ridge, NJ (US)

Correspondence Address: Jeffrey S Boone, Mallinckrodt Inc, 675 McDonnell Boulevard, PO Box 5840, St Louis, MO, 63134, US

(21) Appl. No.: 10/482,876

(22) PCT Filed: Jul. 8, 2002
(86) PCT No.: PCT/US02/21375

Related U.S. Application Data
(60) Provisional application No. 60/304,036, filed on Jul. 9, 2001.

(51) Int. Cl. C11D 1/00

(52) U.S. Cl. 510/175

(57) ABSTRACT

Ammonia-free cleaning compositions for cleaning microelectronic substrates, and particularly to such cleaning compositions useful with and having improved compatibility with microelectronic substrates characterized by sensitive porous dielectrics, low-k or high-k dielectrics and copper metallization. Cleaning compositions for stripping photoresists, cleaning residues from plasma generated organic, organometallic and inorganic compounds, and cleaning residues from planarization processes. The cleaning composition contain one or more non-ammonium producing strong base containing non-nucleophilic, positively charged counter ions and one or more corrosion inhibiting solvent compounds, said corrosion inhibiting solvent compound having at least two sites capable of complexing with metals.

### FIELD OF THE INVENTION

This invention relates to ammonia-free cleaning compositions for cleaning microelectronic substrates, and particularly to such cleaning compositions useful with and having improved compatibility with microelectronic substrates characterized by sensitive low-κ and high-κ dielectrics and copper metallization. The invention also relates to the use of such cleaning compositions for stripping photoresists, cleaning residues from plasma generated organic, organometallic and inorganic compounds, and cleaning residues from planarization processes, such as chemical mechanical polishing (CMP), as well as an additive in planarization slurry residues.

### BACKGROUND TO THE INVENTION

Many photoresist strippers and residue removers have been proposed for use in the microelectronics field as downstream or back end of the manufacturing line cleaners. In the manufacturing process a thin film of photoresist is deposited on a wafer substrate, and then circuit design is imaged on the thin film. Following baking, the unpolymerized resist is removed with a photoresist developer. The resulting image is then transferred to the underlying material, which is generally a dielectric or metal, by way of reactive plasma etch gases or chemical etchant solutions. The etchant gases or chemical etchant solutions selectively attack the photoresist-unprotected area of the substrate. As a result of the plasma etching process, photoresist, etching gas and etched material by-products are deposited as residues around or on the sidewall of the etched openings on the substrate.

Additionally, following the termination of the etching step, the resist mask must be removed from the protected area of the wafer so that the final finishing operation can take place. This can be accomplished in a plasma ashing step by the use of suitable plasma ashing gases or wet chemical strippers. Finding a suitable cleaning composition for removal of this resist mask material without adversely affecting, e.g., corroding, dissolving or dulling, the metal circuitry has also proven problematic.

As microelectronic fabrication integration levels have increased and patterned microelectonic device dimensions have decreased, it has become increasingly common in the art to employ copper metallizations, low-κ and high-κ dielectrics. These materials have presented additional challenges to find acceptable cleaner compositions. Many process technology compositions that have been previously developed for “traditional” or “conventional” semiconductor devices containing Al/SiO₂ or Al(Cu)/SiO₂ structures cannot be employed with copper metallized low-κ or high-κ dielectric structures. For example, hydroxylamine based is stripper or residue remover compositions are successfully used for cleaning devices with Al metallizations, but are practically unsuitable for those with copper metallizations. Similarly, many copper metallized/low-κ strippers are not suitable for Al metallized devices unless significant adjustments in the compositions are made.

Removal of these etch and/or ash residues following the etch and/or ashing process has proved problematic. Failure to completely remove or neutralize these residues can result in the absorption of moisture and the formation of undesirable materials that can cause corrosion to the metal structures. The circuitry materials are corroded by the undesirable materials and produce discontinuances in the circuitry wiring and undesirable increases in electrical resistance.

The current back end cleaners show a wide range of compatibility with certain, sensitive dielectrics and metallizations, ranging from totally unacceptable to marginally satisfactory. Many of the current strippers or residue cleaners are not acceptable for advanced interconnect materials such as porous and low-κ dielectrics and copper metallizations. Additionally, the typical alkaline cleaning solutions employed are overly aggressive towards porous and low-κ and high-κ dielectrics and/or copper metallizations. Moreover, many of these alkaline cleaning compositions contain organic solvents that show poor product stability, especially at higher pH ranges and at higher process temperatures.

### BRIEF SUMMARY OF THE INVENTION

There is, therefore, a need for microelectronic cleaning compositions suitable for back end cleaning operations which compositions are effective cleaners and are applicable for stripping photoresists, cleaning residues from plasma process generated organic, organometallic and inorganic materials, and cleaning residues from planarization process steps, such as chemical mechanical polishing and the like. This invention relates to compositions that are effective in stripping photoresists, preparing/cleaning semiconductor surfaces and structures with good compatibility with advanced interconnect materials such as porous and low-κ and high-κ dielectrics and copper metallizations.

It has been discovered that ammonia (NH₃) and ammonia-derived bases such as ammonium hydroxide and other salts (NH₄X, X=OH, carbonate, etc.) are capable of dissolving/corroding metals such as copper through complex formation. Thus they are poor choices to be used in semiconductor cleaning formulations when compatibility of low-κ dielectrics (i.e., a κ value of 3 or less) or high-κ dielectrics (i.e., a κ value of 20 or greater) and copper metallizations are required. These compounds can generate ammonia through equilibrium process. Ammonia can form complex with metals such as copper and result in metal corrosion/dissolution as set forth in the following equations.

NH₄X⇄NH₃+HX (Equation 1)

Cu+2NH₃→[Cu(NH₃)₂]⁺→[Cu(NH₃)₂]²⁺ (Equation 2)

Thus, ammonium hydroxide and ammonium salts can provide nucleophilic and metal-chelating ammonia (NH₃) through the equilibrium process described in Equation 1, particularly when other bases such as amines and alkanolamines are added. In the presence of oxygen, metals such as copper can be dissolved/corroded through complex formation with ammonia, as described in Equation 2. Such complex formation can further shift the equilibrium (Equation 1) to the right, and provide more ammonia, leading to higher metal dissolution/corrosion.

Generally, sensitive low-κ dielectrics degrade significantly under strong alkaline conditions. Ammonia and ammonia derived bases also show poor compatibility with sensitive dielectrics, such as hydrogen silsesquioxane (HSQ) and methyl silsesquioxane (MSQ). Again, they can provide ammonia and/or other nucleophiles, and thus lead to reaction/degradation of sensitive dielectrics.

It has been discovered that non-ammonium producing strong base alkaline cleaning formulations containing non-nucleophilic, positively charged counter ions (such as tetraalkylammonium) in solvents that contain at least one corrosion inhibiting arm or moiety show much improved compatibility with sensitive porous or low-κ dielectrics and/or copper metallization. The preferred solvent matrices are resistant to strong alkaline conditions, due to steric hindrance effects and/or low or no reactivity to nucleophilic reactions (with respect to nucleophiles such as hydroxide ions). The improved dielectric compatibility is partially achieved due to the absence of undesireable nucleophiles in the compositions. Good compatibility with copper metallization is achieved by selective use of certain copper-compatible or “corrosion inhibiting” solvents. These components can be formulated into semi-aqueous to practically non-aqueous (organic-solvent based) cleaning solutions or slurries.

### DETAILED DESCRIPTION OF THE INVENTION

The novel back end cleaning composition of this invention will comprise one or more of any suitable non-ammonium producing strong base containing non-nucleophilic, positively charged counter ions and one or more of any suitable solvent stable under strong alkaline conditions and having a metal-corrosion inhibiting arm in the solvent compound. Among the suitable non-ammonia producing strong bases containing non-nucleophilic, positively charged counter ions suitable for use in the cleaning compositions of this invention there may be mentioned tetraalkylammonium hydroxides or salts of the formula [(R)₄N⁺]ₚ [X^{-q}], where each R is independently a substituted or unsubstituted alkyl, preferably alkyl of from 1 to 22, and more preferably 1 to 6, carbon atoms (R≠H); and X=OH or a suitable salt anion, such as carbonate and the like; p and q are equal and are integer of from 1 to 3. Suitable strong bases also include KOH and NaOH. Cleaning compositions containing the non-ammonium producing strong bases containing non-nucleophilic, positively charged counter ions show much improved compatibility with porous and low-κ dielectrics and copper metallization. Ammonia-free tetraalkylammonium hydroxides (TAAH) are very strong bases, yet they have been discovered to provide surprisingly improved compatibility with porous and low-κ dielectrics compared to cleaning compositions with ammonium hydroxide. Especially preferred are tetramethylammonium hydroxide, tetrabutylammonium hydroxide and choline hydroxide.

While previous attempts to control or inhibit metal corrosion have involved careful controlling of pH and/or using corrosion inhibiting compounds, such as benzotriazole (BT), at relatively low concentrations of <2% by weight, it has been discovered that unexpected, significant improvement in controlling copper metal corrosion can be provided to the cleaning compositions of this invention when one or more “corrosion inhibiting solvent”, i.e., a solvent compound that has at least two sites capable of complexing with metal is employed.

Preferred as such corrosion inhibiting solvents are compounds having two or more sites capable of complexing with a metal and having one of the two following general formulae:

W—(CR₁R₂)ₙ₁—X—[(CR₁R₂)ₙ₂—Y]_{z}

or

T-[(CR₃R₄)ₘ-Z]_{y}

where W and Y are each independently selected from ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR and —P(O)—(OR)₂; X is alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from —O, —S, —N and —P; Z is selected from hydrogen, —OR₅, —N(R₅)₂, and —SR₅; each of R₃, R₄ and R₅ are each independently selected from hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

In the above definitions alkyl and alkylene are preferably of from 1 to 6 carbon atoms, more preferably of from 1 to 3 carbon atoms, cycloalkyl and cycloalkylene preferably contain from 3 to 6 carbon atoms, and aryl and arylene preferably contain from about 3 to 14 carbon atoms, more preferably from about 3 to 10 carbon atoms. Alkyl is preferably methyl, ethyl or propyl; alkylene is preferably methylene, ethylene or propylene; aryl is preferably phenyl; arylene is preferebly phenylene; hetero-substiituted cycloalkyl is preferably dioxyl, morpholinyl and pyrrolidinyl; and hetero-substituted aryl is preferably pyridinyl.

Some suitable examples are of such corrosion inhibiting solvents include, for example, but are not limited to ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl)acetamide, N-(2-hydroxyethyl) succinimide and 3-(diethylamino)-1,2-propanediol.

The cleaning compositions of this invention containing the non-ammonium producing strong bases can be formulated into aqueous, semi-aqueous or organic solvent-based compositions. The non-ammonium producing, strong bases containing non-nucleophilic, positively charged counter ions can be used with corrosion inhibiting solvents alone or in combination with other stable solvents, preferably one or more polar organic solvents resistant to strong bases and that do not contain unhindered nucleophiles, such as dimethyl sulfoxide (DMSO), sulfolane (SFL), and dimethyl piperidone. The cleaning composition may also optionally contain organic or inorganic acids, preferably weak organic or inorganic acids, hindered amines, hindered alkanolamines, and hindered hydroxylamines. The cleaning compositions can also contain other metal corrosion inhibitors, such as benzotriazole, and aryl compounds containing 2 or more OH or OR groups, where R is alkyl or aryl, such as for example, catechol, pyrogallol, resorcinol and the like. The cleaning compositions may also contain any suitable surfactants, such as for example dimethyl hexynol (Surfynol-61), ethoxylated tetramethyl decynediol (Surfynol-465), polytetrafluoroethylene cetoxypropylbetaine (Zonyl FSK), (Zonyl FSH) and the like.

Any suitable metal ion-free silicate may be used in the compositions of the present invention. The silicates are preferably quaternary ammonium silicates, such as tetraalkyl ammonium silicate (including hydroxy- and alkoxy-containing alkyl groups generally of from 1 to 4 carbon atoms in the alkyl or alkoxy group). The most preferable metal ion-free silicate component is tetramethyl ammonium silicate. Other suitable metal ion-free silicate sources for this invention may be generated in-situ by dissolving any one or more of the following materials in the highly alkaline cleaner. Suitable metal ion-free materials useful for generating silicates in the cleaner are solid silicon wafers, silicic acid, colloidal silica, fumed silica or any other suitable form of silicon or silica. Metal silicates such as sodium metasilicate may be used but are not recommended due to the detrimental effects of metallic contamination on integrated circuits. The silicates may be present in the composition in an amount of from about 0 to 10 wt. %, preferably in an amount of from about 0.1 to about 5 wt. %.

The compositions of the present invention may also be formulated with suitable metal chelating agents to increase the capacity of the formulation to retain metals in solution and to enhance the dissolution of metallic residues on the wafer substrate. The chelating agent will generally be present in the compositions in an amount of from about 0 to 5 wt. %, preferably from an amount of from about 0.1 to 2 wt. %. Typical examples of chelating agents useful for this purpose are the following organic acids and their isomers and salts: (ethylenedinitrilo)tetraacetic acid (EDTA), butylenediaminetetraacetic acid, (1,2-cyclohexylenedinitrilo)tetraacetic acid (CyDTA), diethylenetriaminepentaacetic acid (DETPA), ethylenediaminetetrapropionic acid, (hydroxyethyl)ethylenediaminetriacetic acid (HEDTA), N,N,N′,N′-ethylenediaminetetra(methylenephosphonic) acid (EDTMP), triethylenetetraminehexaacetic acid (TTHA), 1,3-diamino-2-hydroxypropane-N,N,N′,N′-tetraacetic acid (DHPTA), methyliminodiacetic acid, propylenediaminetetraacetic acid, nitrolotriacetic acid (NTA), citric acid, tartaric acid, gluconic acid, saccharic acid, glyceric acid, oxalic acid, phthalic acid, maleic acid, mandelic acid, malonic acid, lactic acid, salicylic acid, catechol, gallic acid, propyl gallate, pyrogallol, 8-hydroxyquinoline, and cysteine. Preferred chelating agents are aminocarboxylic acids such as EDTA, CyDTA and aminophosphonic acids such as EDTMP.

The cleaning compositions may also optionally contain fluoride compounds in cleaning composition, such as for example, tetramethylammonium fluoride, tetrabutylammonium fluoride, and ammonium fluoride. Other suitable fluorides include, for example fluoroborates, tetrabutylammonium fluoroborates, aluminum hexafluorides, antimony fluoride and the like. The fluoride components will be present in an amount of from 0 to 10 wt. %, preferably from about 0.1 to 5 wt. %.

Thus, a wide range of processing/operating pH and temperatures can be used in effectively removing and cleaning photoresists, post plasma etch/ash residues, sacrifical light absorbing materials and anti-reflective coatings (ARC). It has also found that some of this type formulations are particularly effective to clean very difficult samples which contain tantalum in their structure, such as tantalum (Ta) or tantalum nitride barrier layers and tantalum oxide.

The cleaning compositions of this invention will generally comprise from about 0.05 to about 30 wt. % of the non-ammonium producing strong base; from about 0.5 to about 99.95 wt. % of the corrosion inhibiting solvent component; from about 0 to about 95.45 wt. % water or other organic co-solvent; from about 0 to 40 wt. % steric hindered amines, alkanolamines or hydroxylamines; about 0 to 40 wt. % organic or inorganic acids; about 0 to 40 wt. % metal corrosion inhibitor compounds such as benzotriazole, catechol and the like; from about 0 to 5% wt. % surfactant, from about 0 to 10 wt. % silicates, from about 0 to 5 wt. % chelating agents, and from about 0 to 10 wt. % fluoride compounds.

In the following portions of this application the following abbreviations are employed to designate the indicated components.

HEP=1-(2-hydroxyethyl)-2-pyrrolidinone

TMAH=25% tetramethylammonium hydroxide

BT=benzotriazole

DMSO=dimethyl sulfoxide

TEA=triethanolamine

CyDTA=trans-1,2-cyclohexanediamine tetraacetic acid

SFL=sulfolane

EG=ethylene glycol

CAT=catchol

EDTMP=ethylenediamine tetra(methylene phosphonic acid)

DMPD=dimethylpiperidone

TMAF=25% tetramethylammonium fluoride

BSA=benzenesulfonic acid

TMAS=10% tetramethylammonium silicate

Examples of these types of formulations are set forth in the following Tables 1A, 1B, and 1C in which the amounts of the components are indicated in parts by weight.

TABLE 1A
COMPOSITIONS

| COMPONENT | A | B | C | D | E | F | G | H |
|---|---|---|---|---|---|---|---|---|
| HEP | 90 | | | | | | | 90 |
| H₂O | | 7 | 8 | 32 | 16 | 12 | | 8 |
| TMAH | 10.8 | 15 | 16 | 16 | 16 | 24 | 10 | 2.7 |
| BT | 0.11 | | | | | | | 0.11 |
| DMSO | | 16 | | | | | | |
| TEA | | 16 | 16 | 16 | | 24 | 10 | |
| CyDTA | | | 0.2 | 0.2 | | 0.3 | | |
| SFL | | | 16 | 16 | 24 | 24 | 40 | |
| EG | | | | | | | | |
| CAT | | | | | | | | |
| EDTMP | | | | | | | | |
| DMPD | | | | | | | | |

TABLE 1B
COMPOSITIONS

| COMPONENT | I | J | K | L |
|---|---|---|---|---|
| HEP | | | | |
| H₂O | 54 | 54 | 32 | 32 |
| TMAH | 45 | 36 | 4 | 16 |
| BT | | | | |
| DMSO | | | | |
| TEA | 36 | 36 | 16 | 15 |
| CyDTA | | | 0.4 | |
| SFL | | | | |
| EG | 54 | 54 | 48 | |
| CAT | | | 6 | |
| EDTMP | 0.36 | 0.36 | | 0.4 |
| DMPD | | | | 16 |

In Table 1C there are described variations of Compositions D and F of Table 1A with additional added optional components.

TABLE 1C
COMPOSITIONS

| COMPOMENT | M | N | O | P | Q | R | S |
|---|---|---|---|---|---|---|---|
| Composition D | 100 | 100 | 100 | | | | 100 |
| Composition F | | | | 100 | 100 | 100 | |
| TMAF | 2.5 | | | 2.5 | | | |
| TMAH | | 2 | | | 2 | | 2 |
| H₂O | | | | 10 | 10 | 10 | |
| BSA | | | 2 | | | 2 | |
| H₂SO₄ | | 0.5 | | | 0.5 | | 0.5 |
| TMAS | | | | | | | 1 |

The interlayer dielectric (ILD) etch rates for Compositions D and F of Table 1A and Compositions M through S of Table 1C against various dielectrics were evaluated by the following test procedure.

The film thickness of the wafer pieces is measured using a Rudolph Interferometer. The wafer pieces (with ILD material deposited on silicon wafers) were immersed in the designated cleaning compositions at the indicated temperature for 30 minutes, followed by rinsing with de-ionized water and drying under nitrogen flow/stream. The thickness was then measured again following the treatment and the etch rates were then calculated based on the change in film thickness, which are produced by the indicated treatments. The results are set forth in Tables 2, 3, 4 and 5.

TABLE 2
Dielectrics Etch rates (Å/min) at 45 ° C. (30 min)

| Com- | | Black | | | | | FOx- | |
|---|---|---|---|---|---|---|---|---|
| position | CDO | Diamond | SiLK | Coral | FSG | TEOS | 16 | SiN |
| D | 2 | 7 | <1 | <1 | <1 | <1 | — | <1 |
| F | 2 | 7 | <1 | <1 | <1 | <1 | — | <1 |

TABLE 3
Dielectrics Etch rates (Å/min) at 55° C. (30 min)

| Com- | | Black | | | | | FOx- | |
|---|---|---|---|---|---|---|---|---|
| position | CDO | Diamond | SiLK | Coral | FSG | TEOS | 16 | SiN |
| D | — | 29 | <1 | 6 | <1 | 1 | — | <1 |
| F | 2 | 25 | 3 | 4 | <1 | 4 | — | <1 |

TABLE 4
Dielectrics Etch rates (Å/min) at 65° C. (30 min)

| Com- | | Black | | | | | FOx- | |
|---|---|---|---|---|---|---|---|---|
| position | CDO | Diamond | SiLK | Coral | FSG | TEOS | 16 | SiN |
| D | 2 | 42 | 5 | 9 | <1 | 1 | — | <1 |
| F | 2 | 40 | 5 | 8 | <1 | 1 | — | <1 |

TABLE 5
Dielectrics Etch rates (Å/min) at 70° C. (30 min)

| Composition | CDO | SiLK | Coral | TEOS |
|---|---|---|---|---|
| M | 5 | <1 | 12 | 3 |
| N | 5 | <1 | 14 | 3 |
| O | 4 | 2 | 12 | 2 |
| P | <1 | <1 | 5 | 1 |
| Q | <1 | <1 | 3 | <1 |
| R | 2 | <1 | 2 | <1 |
| S | <1 | <1 | <1 | 3 |

In Tables 2, 3, 4 and 5 the dielectric are as follows.

CDO=carbon doped oxide;

Black Diamond™=brand of carbon doped oxide;

SiLK™=organic polymer;

Coral™=brand of carbon doped oxide;

FSG=fluorinated silicate glass;

TEOS=tetraethylorthosilicate;

FOx-16™=flowable oxide (HSQ type); and

SiN=silicon nitride.

The following examples illustrate the excellent Cu compatibility as compared to the relatively poor Al compatibility of the compositions of this invention. The data is presented for Compositions D and F of Table 1A and Composition L of Table 1B.

The copper and aluminum etch rate for cleaning compositions of this invention are demonstrated by the etch rate data in the following Tables 6 and 7. The etch rate was determined utilizing the following test procedure. Pieces of aluminum or copper foil of approximately 13×50 mm were employed. The weight of the foil pieces was measured. After cleaning the foil pieces with 2-propanol, distilled water and acetone and the foil pieces are dried in a drying oven. The cleaned, dried foil pieces were then placed in loosely capped bottles of preheated cleaning compositions of the invention and placed in a vacuum oven for a period of from two to twenty-four hours at the indicated temperature. Following treatment and removal from the oven and bottles, the cleaned foils were rinsed with copious amounts of distilled water and dried in a drying oven for about 1 hour and then permitted to cool to room temperature, and then the etch rate determined based on weight loss or weight change.

TABLE 6
Metal etch rates (Å/min) at 55° C. (24 hours Study)

| Composition | Cu Etch rates | Al Etch Rates |
|---|---|---|
| D | <1 | >1,000 |
| F | <1 | >1,000 |

TABLE 7
Metal etch rates (Å/min) at 65° C. (24 hours Study)

| Composition | Cu Etch rates | Al Etch Rates |
|---|---|---|
| D | <1 | >1,000 |
| F | <1 | >1,000 |
| L | 1 | |

The advantage of having the corrosion inhibiting solvents of this invention present in the composition is demonstrated by the following examples utilizing various corrosion inhibiting solvents, with comparable data for two comparison examples with no corrosion inhibiting solvent present. The Cu etch rate test was conducted in the same manner as described herein before and the results are set forth in Table 8.

TABLE 8
Cu etch rates (Å/hour) at 70-75° C. (oven temperature)
(24 hours test)

| Composition | | | Cu Etch |
|---|---|---|---|
| Components | | Inhibitor | Rate |
| Parts by Weight | Inhibitor Identity | wt % | (Å/hour) |
| 22:32 | None | 0 | 220 |
| 25% TMAH- | | | |
| DMSO | | | |
| 22:16:16 | 2-(methylamino)ethanol | 30 | <10 |
| 25% TMAH- | | | |
| DMSO-2- | | | |
| (methylamino) | | | |
| ethanol | | | |
| 22:16:16 | N,N-dimethylethanol- | 30 | <10 |
| 25% TMAH- | amine | | |
| DMSO-N,N- | | | |
| dimethylethanolamine | | | |
| 22:16:16 | 3-(Diethylamino)-1,2- | 30 | <10 |
| 25% TMAH- | propandiol | | |
| DMSO-3- | | | |
| (Diethylamino)- | | | |
| 1,2-propandiol | | | |
| 32:15:7 | None | 0 | 220 |
| DMSO-25% | | | |
| TMAH-H₂O | | | |
| 16:15:7:16 | Triethanolamine | 30 | <10 |
| DMSO-25% | | | |
| TMAH-H₂O- | | | |
| triethanolamine | | | |
| 16:15:7:16 | Diethanolamine | 30 | <10 |
| DMSO-25% | | | |
| TMAH-H₂O- | | | |
| diethanolamine | | | |
| 16:15:7:16 | Monoethanolamine | 30 | <10 |
| DMSO-25% | | | |
| TMAH-H₂O- | | | |
| monoethanolamine | | | |
| 16:15:7:16 | HEP | 30 | <10 |
| DMSO-25% | | | |
| TMAH-H₂O- | | | |
| HEP | | | |
| 24:15:7:8 | Triethanolamine | 15 | <10 |
| DMSO-25% | | | |
| TMAH-H₂O- | | | |
| triethanolamine | | | |
| 24:15:7:8 | Diethanolamine | 15 | <10 |
| DMSO-25% | | | |
| TMAH-H₂O- | | | |
| diethanolamine | | | |
| 24:15:7:8 | Monoethanolamine | 15 | <10 |
| DMSO-25% | | | |
| TMAH-H₂O- | | | |
| monoethanolamine | | | |
| 24:15:7:8 | HEP | 15 | <10 |
| DMSO-25% | | | |
| TMAH-H₂O- | | | |
| HEP | | | |

Similar Cu etch rates test were conducted with a formulation containing TMAH, DMSO and H₂O, with and without a corrosion inhibiting solvent and the etch rate data is presented in Table 9.

TABLE 9
Cu etch rates (Å/hour) at 70-75° C. (oven temperature)
(24 hours test)

| | | Cu Etch Rate |
|---|---|---|
| Inhibitor Identity | Inhibitor wt % | (Å/hour) |
| None | 0 | 140 |
| 2-amino-2-methyl-1- | 30 | <10 |
| propanol | | |
| 1-amino-2-propanol | 30 | <10 |
| 2-(2-aminoethoxy)- | 30 | <10 |
| ethanol | | |

Another series of Cu etch rate studies was conducted with a formulation of SFL and TMAH with and without a corrosion inhibiting solvent present in the formulation. The data for such test is presented in Table 10.

TABLE 10
Cu etch rates (Å/hour) at 70-75° C. (oven temperature)
(24 hours test)

| Parts by weight | | | |
|---|---|---|---|
| Composition | | | Cu Etch Rate |
| components | Inhibitor Identity | Inhibitor wt % | (Å/hour) |
| 10:50 | None | 0 | 30 |
| 25% TMAH-SFL | | | |
| 10:40:10 | TEA | 17 | <10 |
| 25% TMAH-SFL-TEA | | | |

The following example demonstrates the superior compatibility of the non-ammonium strong bases of this invention, e.g. TMAH, in comparison to the ammonium bases, e.g. ammonium hydroxide (NH₄OH), with sensitive low-κ dielectrics, such as hydrogen silsesquioxane (HSQ) type FOx-15™ flowable is oxide. The test procedure is as follows. Wafer samples coated with dielectric films were immersed in a magnetically stirred wet chemical solution (stirring rate 300 rpm), followed by isopropanol and distilled water rinses. The samples were then dried with a nitrogen stream before IR analysis

Transmittance IR spectra were obtained with a Nicolet 740 FTIR spectrometer using a deuterated triglycine sulfate (DTGS) detector. Spectra were acquired with 4 cm⁻¹ resolution and averaged over 32 scans. Fourier Transform Infrared (FTIR) analysis provides a way of monitoring the structural changes of HSQ dielectrics. The infrared absorption band assignments of typical deposited HSQ films are as follows.

Assignments of Infrared Absorption Bands of HSQ Dielectric

| Absorption Frequencies (cm⁻¹) | Band Assignment |
|---|---|
| 2,250 | Si—H Stretch |
| 1,060-1,150 | Si—O—Si Stretch |
| 830-875 | H—Si—O hybrid vibration |

The content of Si—H bonds in HSQ films can be determined by measuring the peak areas of Si—H absorption bands at 2,250 cm⁻¹. The use of the silicon wafer's inherent absorption at 650-525 cm⁻¹ (from Si—Si lattice bonds and Si—C impurities) as the internal standard/reference resulted in quantitative IR analyses with good precision (relative standard deviation: 2-5%).

TABLE 11
Compatibility with FOx-15 HSQ Low-κ Dielectrics

| | % Si—H Remaining | % Film Thickness |
|---|---|---|
| Parts by weight | after Treatment (by | Remaining after |
| Composition components | FTIR measurement) | treatment |
| 90:8:1:0.11; HEP-H₂O— | 20 | 96 |
| NH₄OH-BT | | |
| 90:8:2.66:0.11; HEP-H₂O- | 92.5 | 100 |
| TMAH-BT | | |

Original film thickness: 4,500 Å.

The cleaning capability of compositions of this invention is illustrated in the following tests in which a microelectronic structure that comprised a wafer of the following via structure, namely photoresist/carbon doped oxide/silicon nitride/copper with the silicon nitride punched through to expose copper, was immersed in cleaning solutions for the indicated temperature and time, were then water rinsed, dried and then the cleaning determined by SEM inspection. The results are set forth in Table 12.

TABLE 12

| Composition and Process | |
|---|---|
| Condition | Cleaning Performance |
| Composition F, 75° C., | 100% Clean; Removed all the PR (bulk PR and |
| 40 min | hardened, polymeric “via collar/fence”) |
| Composition D, 75° C., | 100% Clean; Removed all the PR (bulk PR and |
| 20 min | hardened, polymeric “via collar/fence”) |
| Composition B, 75° C., | 100% Clean; Removed all the PR (bulk PR and |
| 40 min | hardened, polymeric “via collar/fence”) |

The same cleaning test was conducted on a microelectronic substrate that comprised a wafer of the following line structure, namely photoresist/tantalum nitride/FSG/copper. Two prior art commercial cleaning products were also tested for comparison purposes. The cleaning results are set forth in Table 13.

TABLE 13

| Composition and | | Substrate |
|---|---|---|
| Process Condition | Cleaning Performance | Compatibility |
| Composition F, | 100% Clean; Removed all | 100% compatible |
| 75° C., 20 min | the PR (bulk PR and | with TaN and FSG |
| | hardened, polymeric | |
| | “fence”) | |
| EKC-265 ™, | Not Clean; Removed bulk | |
| 75° C., 20 min | PR, but hardened, polymeric | |
| | “fence” remained | |
| ATMI ST-250, | Not clean; nothing is | |
| 30° C., 20 min | changed | |
| (a fluoride-based | | |
| stripper) | | |

A similar cleaning test was conducted on a microelectronic structure that comprised a wafer of the following via structure, namely photoresist/carbon doped oxide/silicon nitride/copper without the silicon nitride punched through to expose copper. The results are set forth in TABLE 14.

TABLE 14

| Composition and | |
|---|---|
| Process Condition | Cleaning Performance |
| Composition D, | 100% Clean; Removed all the PR (bulk PR and |
| 70° C., 20 min | hardened, polymeric “via collar/fence”) |

A similar cleaning test was conducted on a microelectronic structure that comprised a wafer of the following via structure, namely pTEOS/Coral/SiN/Coral/SiN/copper. The results are set forth in TABLE 15.

TABLE 15

| Composition and | | |
|---|---|---|
| Process Condition | Cleaning Performance | Substrate Compatibility |
| Composition B, | 100% Clean; Removed | Compatible with Cu metal, |
| 65° C., 20 min | all the residues | dielectrics and etch |
| | | stop/barrier layers. |

With the foregoing description of the invention, those skilled in the art will appreciate that modifications may be made to the invention without departing from the spirit and scope of thereof. Therefore, it is not intended that the scope of the invention be limited to the specific embodiments illustrated and described.

I claim:

1. A cleaning composition for cleaning microelectronic substrates, said cleaning composition comprising:
from about 0.05% to 30% by weight of one or more non-ammonium producing strong base containing non-nucleophilic, positively charged counter ions;
from about 0.5 to about 99.95% by weight of one or more corrosion inhibiting solvent compounds, said corrosion inhibiting solvent compound having at least two sites capable of complexing with metals;
from about 0 to about 99.45% by weight water or other organic co-solvent;
from about 0 to 40% by weight a steric hindered amine or alkanolamine;
from about 0 to 40% by weight an organic or inorganic acid;
from about 0 to 40% by weight of an other metal corrosion inhibitor compounds;
from about 0 to 5% by weight a surfactant;
from about 0 to 10% by weight of a metal ion free silicate compound;
from about 0 to 5% by weight of a metal chelating agent; and
from about 0 to 10% by weight of a fluoride compound.

2. A cleaning composition of claim 1 wherein the non-ammonium producing strong base is a tetraalkylammonium hydroxide or salt thereof.

3. A cleaning composition of claim 2 wherein the tetraalkylammonium hydroxide or salt is a compound of the formula
[(R)₄N⁺]ₚ[X^{-q}]
wherein each R is independently a substitured or unsubstituted alkyl group; X is OH or a salt anion; and p and q are equal and are integers of from 1 to 3.

4. A cleaning composition of claim 3 wherein R is an alkyl group containing 1 to 22 carbon atoms and X is OH.

5. A cleaning composition of claim 4 wherein R is an alkyl group of from 1 to 6 carbon atoms.

6. A cleaning composition of claim 1 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR and —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

7. A cleaning composition of claim 2 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR and —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

8. A cleaning composition of claim 3 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR and —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

9. A cleaning composition of claim 4 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR and —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

10. A cleaning composition of claim 5 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR and —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

11. A cleaning composition of claim 10 wherein in the definition of R through R₅ the alkyl group has from 1 to 6 carbon atoms and the aryl group has from 3 to 14 carbon atoms.

12. A cleaning composition of claim 1 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl) acetamide, N-(2-hydroxyethyl) succinimide and 3-(diethylamino)-1,2-propanediol.

13. A cleaning composition of claim 2 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl) acetamide, N-(2-hydroxyethyl) succinimide and 3-(diethylamino)-1,2-propanediol.

14. A cleaning composition of claim 3 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl) acetamide, N-(2-hydroxyethyl) succinimide and 3-(diethylamino)-1,2-propanediol.

15. A cleaning composition of claim 4 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl) acetamide, N-(2-hydroxyethyl) succinimide and 3-(diethylamino)-1,2-propanediol.

16. A cleaning composition of claim 5 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl) acetamide, N-(2-hydroxyethyl) succinimide and 3-(diethylamino)-1,2-propanediol.

17. A cleaning composition of claim 1 comprising water or at least one other organic co-solvent selected from the group consisting of dimethyl sulfoxide, sulfolane, and dimethylpiperidone.

18. A cleaning composition of claim 6 comprising water or at least one other co-solvent selected from the group consisting of dimethyl sulfoxide, sulfolane, and dimethylpiperidone.

19. A cleaning composition of claim 11 comprising water or at least one other organic co-solvent selected from the group consisting of dimethyl sulfoxide, sulfolane, and dimethylpiperidone.

20. A cleaning composition of claim 16 comprising water or at least one other organic co-solvent selected from the group consisting of dimethyl sulfoxide, sulfolane, and dimethylpiperidone.

21. A cleaning composition of claim 1 comprising tetramethylammonium hydroxide, triethanolamine, trans-1,2-cyclohexanediamine tetraacetic acid, sulfolane and water.

22. A cleaning composition of claim 1 comprising tetramethylammonium hydroxide, 1-(2-hydroxyethyl)-2-pyrrolidinone and water.

23. A cleaning composition of claim 1 comprising tetramethylammonium hydroxide, dimethyl sulfoxide, triethanolamine and water.

24. A cleaning composition of claim 1 comprising tetramethylammonium hydroxide, triethanolamine, ethylene glycol, ethylenediamine tetra(methylene phosphonic acid and water.

25. A process for cleaning a microelectronic substrate having at least one of a porous dielectric, a low-κ or high-κ dielectric and copper metallization, the process comprising contacting the substrate with a cleaning composition for a time sufficient to clean the substrate, wherein the cleaning composition comprises:
from about 0.05% to 30% by weight of one or more non-ammonium producing strong base containing non-nucleophilic, positively charged counter ions;
from about 0.5 to about 99.95% by weight of one or more corrosion inhibiting solvent compounds, said corrosion inhibiting solvent compound having at least two sites capable of complexing with metals;
from about 0 to about 99.45% by weight water or other organic co-solvent;
from about 0 to 40% by weight a steric hindered amine or alkanolamine;
from about 0 to 40% by weight an organic or inorganic acid;
from about 0 to 40% by weight of an other metal corrosion inhibitor compounds;
from about 0 to 5% by weight a surfactant;
from about 0 to 10% by weight of a metal ion free silicate compound;
from about 0 to 5% by weight of a metal chelating agent; and
from about 0 to 10% by weight of a fluoride compound.

26. A process of claim 24 wherein the non-ammonium producing strong base is a tetraalkylammonium hydroxide or salt thereof.

27. A process of claim 25 wherein the tetraalkylammonium hydroxide or salt is a compound of the formula
[(R)₄N⁺]ₚ[X^{-q}]
wherein each R is independently a substituted or unsubstituted alkyl group; X is OH or a salt anion; and p and q are equal and are integers of from 1 to 3.

28. A process of claim 26 wherein R is an alkyl group containing 1 to 22 carbon atoms and X is OH or carbonate.

29. A process of claim 27 wherein R is an alkyl group of from 1 to 6 carbon atoms.

30. A process of claim 25 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR and —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

31. A process of claim 26 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR and —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

32. A process of claim 27 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

33. A process of claim 28 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, —S(O)₂, —N, —NH—R, —NR₁R₂, —N—C(O)—R, —NR₁—C(O)—R₂, —P(O), —P(O)—OR and —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

34. A process of claim 29 wherein the corrosion inhibiting solvent compound is a compound selected from the formulae:
W—(CR₁R₂)ₙ₁—X—[(CR₁R₂)ₙ₂—Y]_{z}
or
T-[(CR₃R₄)ₘ-Z]_{y}
where W and Y are each independently selected from the group consisting of ═O, —OR, —O—C(O)—R, —C(O)—, —C(O)—R, —S, —S(O)—R, —SR, —S—C(O)—R, —S(O)₂—R, S(O)₂, —N, —NH—R, —NR₁R₂, —N—C(O)—R, —NR₁—C(O)—R₂, —P(O), —P(O)—OR and —P(O)—(OR)₂; X is selected from the group consisting of alkylene, cycloalkylene or cycloalkylene containing one or more hetero atoms selected from O, S, N and P atoms, and arylene or arylene containing one or more hetero atoms selected from O, S, N and P atoms; each R, R₁ and R₂ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; each of n1 and n2 is independently an integer of from 0 to 6; and z is an integer of from 1 to 6 when X is alkylene, cycloalkylene or arylene; and z is an integer of from 0 to 5 when X is cycloalkylene containing one or more hetero atoms selected from O, S, N and P atoms or arylene containing one or more hetero atoms selected from O, S, N and P atoms; T is selected from the group consisting of —O, —S, —N and —P; Z is selected from the group consisting of hydrogen, —OR₅, —N(R₅)₂, and —SR₅; each of R₃, R₄ and R₅ are each independently selected from the group consisting of hydrogen, alkyl, cycloalkyl or cycloalkyl containing one or more hetero atoms selected from O, S, N and P atoms, and aryl or aryl containing one or more hetero atoms selected from O, S, N and P atoms; m is an integer of from 0 to 6 and y is an integer of from 1 to 6.

35. A process of claim 34 wherein from about 0 to 10% by weight of a metal ion free silicate compound; and from about 0 to 5% by weight of a metal chelating agent. the alkyl group has from 1 to 6 carbon atoms and the aryl group has from 3 to 14 carbon atoms.

36. A process of claim 25 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl)acetamide, N-(2-hydroxyethyl) succinimide and 3-(diethylamino)-1,2-propanediol.

37. A process of claim 26 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl)acetamide, N-(2-hydroxyethyl) succinimide and 3-(diethylamino)-1,2-propanediol.

38. A process of claim 27 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl)acetamide, N-(2-hydroxyethyl) succinimide and 3-(diethylamino)-1,2-propanediol.

39. A process of claim 28 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl)acetamide, N-(2-hydroxyethyl) succinimide and 3-(diethylamino)-1,2-propanediol.

40. A process of claim 29 wherein the corrosion inhibiting solvent is selected from the group consisting of ethylene glycol, diethylene glycol, glycerol, diethylene glycol dimethyl ether, monoethanolamine, diethanolamine, triethanolamine, N,N-dimethylethanolamine, 1-(2-hydroxyethyl)-2-pyrrolidinone, 4-(2-hydroxyethyl)morpholine, 2-(methylamino)ethanol, 2-amino-2-methyl-1-propanol, 1-amino-2-propanol, 2-(2-aminoethoxy)-ethanol, N-(2-hydroxyethyl)acetamide, N-(2-hydroxyethyl) succinimide and 3-(diethylamino)-1,2-propanediol.

41. A process of claim 25 wherein the cleaning composition comprises water or at least one other organic co-solvent selected from the group consisting of dimethyl sulfoxide, sulfolane, and dimethyl piperidone.

42. A process of claim 29 wherein the cleaning composition comprises water or at least one other co-solvent selected from the group consisting of dimethyl sulfoxide, sulfolane, and dimethyl piperidone.

43. A process of claim 35 wherein the cleaning composition comprises water or at least one other organic co-solvent selected from the group consisting of dimethyl sulfoxide, sulfolane, and dimethyl piperidone.

44. A process of claim 40 wherein the cleaning composition comprises water or at least one other organic co-solvent selected from the group consisting of dimethyl sulfoxide, sulfolane, and dimethyl piperidone.

45. A process of claim 25 wherein the cleaning composition comprises tetramethylammoniumn hydroxide, triethanolamine, trans-1,2-cyclohexanediamine tetraacetic acid, sulfolane and water.

46. A process of claim 25 wherein the cleaning composition comprises tetramethylammoniun hydroxide, 1-(2-hydroxyethyl)-2-pyrrolidinone and water.

47. A cleaning composition of claim 25 comprising tetramethylammonium hydroxide, dimethyl sulfoxide, triethanolamine and water.

48. A process of claim 25 wherein the cleaning composition comprising tetramethylammonium hydroxide, triethanolamine, ethylene glycol, ethylenediamine tetra(methylene phosphonic acid and water.
